(19) United States
(12) Patent Application Publication
(10) Pub. No.: US 2024/0403660 A1
(43) Pub. Date: Dec. 5, 2024

(54) CONSTRAINED DEVICE PLACEMENT USING NEURAL NETWORKS

(71) Applicant: Google LLC, Mountain View, CA (US)

(72) Inventors: Xinfeng Xie, ISLA VISTA, CA (US); Azalia Mirhoseini, Mountain View, CA (US); James Laudon, Madison, WI (US); Phitchaya Mangpo Phothilimthana, Mountain View, CA (US); Sudip Roy, Sunnyvale, CA (US); Prakash Janardhana Prabhu, Bangalore (IN); Ulysse Beaugnon, Meudon (FR); Yanqi Zhou, Sunnyvale, CA (US)

(21) Appl. No.: 18/697,182

(22) PCT Filed: Oct. 6, 2022
(86) PCT No.: PCT/US2022/045915

§ 371 Date: Mar. 29, 2024

(30) Foreign Application Priority Data
Oct. 6, 2021 (IN) 202121045497

(51) Int. Cl. G06N 5/01; G06N 3/042; G06N 3/045; G06N 3/092

(52) U.S. Cl. CPC G06N 5/01; G06N 3/042; G06N 3/045; G06N 3/092

(57) ABSTRACT

Systems and methods for determining a placement for computational graph across multiple hardware devices. One of the methods includes generating a policy output using a policy neural network and using the policy output to generate a final placement that satisfies one or more constraints.

### CROSS-REFERENCE TO RELATED APPLICATIONS

This application claims the benefit of priority Indian application No. 202121045497, filed Oct. 6, 2021, the entirety of which is incorporated herein by reference.

### BACKGROUND

This specification relates to determining a placement of computational graphs across multiple devices using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations determines a placement for a computational graph across multiple devices, e.g., multiple hardware accelerators, e.g., Tensor Processing Units (TPUs), Graphics Processing Units (GPUs), or other ASICS, or FPGAs.

The subject matter described in this specification can be implemented in particular embodiments so as to realize one or more of the following advantages.

Many computational graphs, e.g., graphs representing machine learning (ML) models that have a large number of parameters, e.g., are so large that they must be partitioned across many hardware devices, e.g., accelerators such as GPUs, TPUs, or other ASICs, in order to be executed efficiently. One commonly used partitioning strategy is through device placement where operations in a computation graph are assigned to run on multiple hardware devices, e.g., using heuristics or using outputs generated by neural networks.

However, finding a placement that not only respects device resource constraints (e.g. a constraint on peak memory usage during execution of the graph) but also minimizes execution time, i.e., maximizes throughput, is non-trivial. The complexity of the problem is further exacerbated by novel device architectures and interconnection schemes where additional constraints, e.g., acyclic dataflow caused by a uni-directional interconnect, are hard to encapsulate in a machine learning model. In other words, it can be extremely difficult to train a machine learning model to generate a placement that results in a low execution time while also respecting these additional constraints.

Although prior reinforcement learning (RL)-based methods have been used for device placement tasks, they are unable to find even feasible solutions in the presence of such complex constraints due to an extremely sparse reward space. That is, because the neural network very rarely, if at all, receives a high reward during the RL training (because a high reward requires a placement that satisfies the constraints to be generated), training the neural network through RL becomes very difficult or even impossible.

The described techniques, on the other hand, use a deep neural network approach combined with a constraint solver to generate high quality placements that satisfy even strict constraints. In particular, by incorporating a constraint engine that applies constraint solving techniques to generate successful placements using outputs generated by the neural network both during training and inference, the described techniques can be used to generate high quality placements for a variety of placement tasks under a variety of constraints. For example, the described techniques can be used for a real multi-die chip placement problem with strict constraints, e.g., on a set of edge accelerators with stringent constraints. The described techniques are able to generate placements with higher throughput than conventional techniques while satisfying the constraints and can also generalize to new computational graphs with no fine-tuning or with minimal fine-tuning.

Additionally, the described techniques can, in some cases, use an iterative process to generate a final policy output when generating a placement. This iterative process is non-auto-regressive but approximates the results of an auto-regressive processes that would place each node conditioned on the placement of previous nodes. Performing an auto-regressive placement can ne computationally infeasible for real-world large computation graphs due to the very large number of nodes in the real-world large computation graphs. The described iterative process, on the other hand, can yield results that approach that of an auto-regressive placement process while consuming many fewer computational resources.

While this specification describes placing machine learning operations, the techniques described in this specification can be used to place any collection of operations that can be described by a computational graph across a plurality of hardware devices.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example device placement system that determines a placement for a computational graph.

FIG. 2 is a flow diagram of an example process for determining a placement for a computational graph.

FIG. 3 is a flow diagram of an example process for generating a policy output.

Like reference numbers and designations in the various drawings indicate like elements.

### DETAILED DESCRIPTION

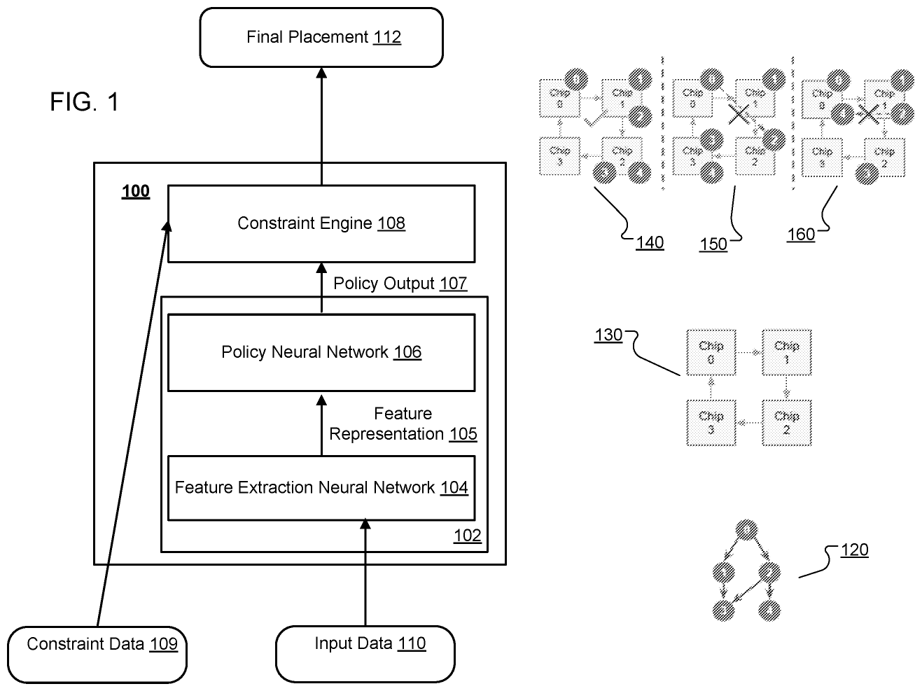

FIG. 1 illustrates a device placement system 100 that determines a placement for a computational graph across multiple devices, e.g., multiple hardware accelerators, e.g., Tensor Processing Units (TPUs), Graphics Processing Units (GPUs), or other ASICS, or FPGAs.

The computational graph includes a plurality of nodes and a plurality of edges. Each edge connects a respective pair of nodes from the computational graph. More specifically, each node in the computational graph represents an operation and edges represent data dependencies between operations. That is, an edge that connects a first node to a second node represents that the operation represented by the second node receives as input at least a portion of the output of the operation represented by the first node.

FIG. 1 shows an example computational graph 120 to be placed on an example set of hardware devices 130.

The computational graph 120 includes five nodes (0, 1, 2, 3, and 4) that each represent operations. Node 0 is connected by an outgoing edge to nodes 1 and 2, indicating that the operations represented by nodes 1 and 2 each receive, as input, an output generated by the operation represented by node 0. Node 1 is connected by an outgoing edge to node 3, indicating that the operation represented by node 3 receives, as input, an output generated by the operation represented by node 1. Node 2 is connected by an outgoing edge to nodes 3 and 4, indicating that the operations represented by nodes 3 and 4 each receive, as input, an output generated by the operation represented by node 2.

The set of hardware devices 130 includes four devices, that, in the example of FIG. 1, are computer chips 0, 1, 2, and 3. For example, the chips may be ASICs that are designed to accelerate computations associated with neural networks, e.g., by performing matrix multiplication and other common neural network operations in hardware. In the example of FIG. 1, the chips are connected by uni-directional links and each chip is only connected to one other chip by a uni-directional link.

In some cases, the computational graph represents machine learning operations, i.e., operations for training a machine learning model to perform a machine learning task or operations for performing inference using a trained machine learning model that has already been trained to perform the machine learning task. Performing inference using the machine learning refers to processing an input using the machine learning model to generate an output for the machine learning task. Operations for training the machine learning model include the operations required to process a batch of one or more inputs using the model to generate a respective output for each input in the batch and the operations required to update the parameters of the model using the respective outputs, e.g., by computing gradients of an objective function for the training and then applying an optimizer to the gradients to update the parameters.

The machine learning task performed by the machine learning model can be any appropriate machine learning task.

For example, the machine learning task can be a computer vision task (also referred to as an “image processing task”). In other words, the machine learning model can be a convolutional neural network or different type of neural network (e.g., a transformer based neural network) that is configured to receive an input image and to process the input image to generate a network output for the input image, i.e., to perform some kind of image processing task. In this specification, processing an input image refers to processing the intensity values of the pixels of the image using a neural network.

For example, the task may be image classification and the output generated by the neural network for a given image may be scores for each of a set of object categories, with each score representing an estimated likelihood that the image contains an image of an object belonging to the category.

As another example, the task can be image embedding generation and the output generated by the neural network can be a numeric embedding of the input image.

As yet another example, the task can be object detection and the output generated by the neural network can identify locations in the input image, e.g., bounding boxes or other geometric regions within the image, at which particular types of objects are depicted.

As yet another example, the task can be image segmentation and the output generated by the neural network can define for each pixel of the input image which of multiple categories the pixel belongs to.

More generally, however, the task can be any of a variety of tasks, including tasks that process inputs other than images.

As an example, if the inputs to the machine learning model are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the machine learning model are features of an impression context for a particular advertisement, the output generated by the machine learning model may be a score that represents an estimated likelihood that the particular advertisement will be clicked on.

As another example, if the inputs to the machine learning model are features of a personalized recommendation for a user, e.g., features characterizing the context for the recommendation, e.g., features characterizing previous actions taken by the user, the output generated by the machine learning model may be a score for each of a set of content items, with each score representing an estimated likelihood that the user will respond favorably to being recommended the content item.

As another example, if the input to the machine learning model is a sequence of text in one language, the output generated by the machine learning model may be a score for each of a set of pieces of text in another language, with each score representing an estimated likelihood that the piece of text in the other language is a proper translation of the input text into the other language.

As another example, the task may be an audio processing task. For example, if the input to the machine learning model is a sequence representing a spoken utterance, the output generated by the machine learning model may be a score for each of a set of pieces of text, each score representing an estimated likelihood that the piece of text is the correct transcript for the utterance. As another example, the task may be a keyword spotting task where, if the input to the machine learning model is a sequence representing a spoken utterance, the output generated by the machine learning model can indicate whether a particular word or phrase (“hotword”) was spoken in the utterance. As another example, if the input to the machine learning model is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks. Optionally, the network input can include an identifier for the individual natural language understanding task to be performed on the network input. As another example, the neural network can be configured to perform multiple individual image processing or computer vision tasks, i.e., by generating the output for the multiple different individual image processing tasks in parallel by processing a single input image.

To generate a placement 112, the system 100 obtains graph data 110 specifying a computational graph that represents the operations as nodes and data dependencies between the operations as edges between nodes. The graph data includes a vector for each node that contains information for the operation that the node represents, e.g., operation type of the operation (e.g., selected from a predetermined set of operation types), input tensor shape (e.g., the dimensions of the input tensor to the operation), and output tensor shape (e.g., the dimensions of the output tensor of the operation). The graph data 110 also includes adjacency data representing the connectivity among nodes. For example, the adjacency data can be represented as an adjacency matrix A, such that if A [i][j]=1, this means that there is an edge from node i to node j in the graph. Otherwise, A [i][j]=0.

The system then determines a placement 112 that assigns each of the operations specified by the received data 110 to a respective device from a plurality of hardware devices and that satisfies one or more constraints on the placement that are specified in constraint data 109.

That is, the system 100 is required to generate a placement that assigns each operation to one device and that satisfies one or more constraints. Generally, each of the constraints are imposed due to the configuration of the plurality of devices, i.e., such that placements that violate any of the constraints will result in one or more of the devices not being able to execute one or more of the operations that are assigned to the device.

For example, certain devices may only be configured to handle certain types of operations or only have sufficient memory to store the required data for a proper subset of the operations in the graph.

As another example, the communication links between the devices may impose one or more constraints on the execution of the graph. For example, if the devices are connected with uni-directional links as in the example of FIG. 1, an operation that consumes an output from another operation must either be assigned to the same device as the other operation or be an end-point of a link from the device to which the other operation is assigned.

As another example, if each device is connected to only a proper subset of the other devices by an inter-chip link as in the example of FIG. 1, an operation that consumes an output from another operation must either be assigned to the same device as the other operation or be assigned to another device that is connected to the device to which the other operation is assigned by a link.

FIG. 1 shows three example placements 140, 150, and 160 for the computational graph 120 onto the devices 130. Each of the placements 140, 150, and 160 assigns each node in the graph 120 onto one of the devices in the set of devices 130.

In particular, the first example placement 140 assigns node 0 to chip 0, node 1 to chip 1, node 2 to chip 1, node 3 to chip 2, and node 4 to chip 2.

The second example placement 140 assigns node 0 to chip 0, node 1 to chip 1, node 2 to chip 2, node 3 to chip 3, and node 4 to chip 3.

The third example placement 140 assigns node 0 to chip 0, node 1 to chip 1, node 2 to chip 1, node 3 to chip 2, and node 4 to chip 0.

In this example, the constraints for the placement specify that, since the devices are connected with uni-directional links, an operation that consumes an output from another operation must either be assigned to the same device as the other operation or be an end-point of a link from the device to which the other operation is assigned. Additionally, since each device is connected to only a proper subset of the other devices by an inter-chip link, an operation that consumes an output from another operation must either be assigned to the same device as the other operation or be assigned to another device that is connected to the device to which the other operation is assigned by a link.

Thus, the first example placement 140 is a valid placement, i.e., all of the assignments in the placement 140 satisfy all of the constraints, while the placements 150 and 160 are invalid, i.e., at least one of the assignments in each of the placements causes the placement to violate one of the constraints.

In particular, in the placement 150, the assignment of node 2 to chip 2 and node 0 to chip 0 causes the placement 150 to violate the second constraint, because the operation represented by node 2 receives as input the output of the operation represented by node 0, but node 0 is not assigned to the same device as node 2 and is not assigned to another device that is connected to chip 2 by a link. That is, chip 2 not connected by a link to chip 0 and the placement 150 therefore violated the constraints due to node 0 being connected by an outgoing edge to node 2 in the computational graph.

In the placement 160, the assignment of node 2 to chip 1 and node 4 to chip 0 causes the placement 150 to violate the first constraint, because the operation represented by node 4 receives as input the output of the operation represented by node 4, but chip 0 is not the end-point of the uni-directional link between chip 0 and chip 1, i.e., data cannot travel from chip I to chip 0 along the uni-direction link between these two devices.

To generate a high performing placement, e.g., a high throughput placement, that satisfies the constraints, the system 100 processes the graph data 110 using a placement neural network 102 to generate a policy output 107 that includes, for each node, a respective score distribution that includes a respective score for each of the plurality of hardware devices. That is, the policy output 107 includes a respective set of scores for each node in the graph. The set of scores for a given node includes a respective score for each of the hardware devices.

The placement neural network 102 can generally have any appropriate architecture that allows the neural network 102 to process the graph data 110 to generate the score distributions for the nodes in the graph.

In the example of FIG. 1, the placement neural network 102 includes a feature extraction neural network 104 and a policy neural network 106.

The feature extraction neural network 104 processes the graph data 110 to generate a feature representation 105 of the computational graph. As a particular example, the feature extraction neural network 104 can be a graph neural network and the feature representation 105 of the computational graph can include a respective embedding of each of the nodes in the computational graph. An embedding, as used in this specification, is an ordered collection of numeric values that has a specified dimensionality, e.g., a vector of floating point or other numeric values. The graph neural network can have any appropriate graph neural network architecture, e.g., a GraphSAGE architecture, a Relational Graph Convolutional Network (R-GCN), a Graph Isomorphism Network (GIN), and so on.

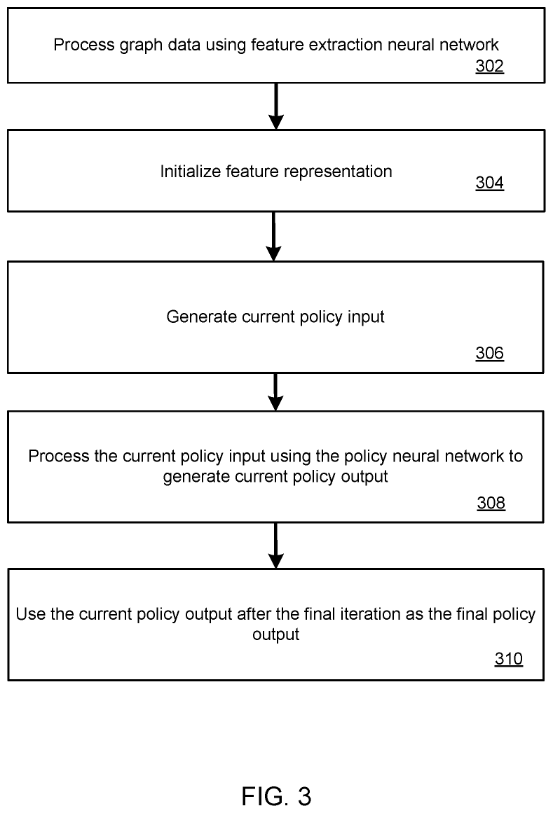

The policy neural network 106 processes a policy input that includes the feature representation 105 of the computational graph to generate the policy output 107. In some cases, as will be described below with reference to FIG. 3, the policy input also includes a state representation that includes a respective state embedding for each of the nodes in the computational graph. For example, the policy input can include, for each node, a combination of, e.g., a concatenation of, an average of, or a sum of, the embedding of the node generated by the neural network 104 and the state embedding of the node.

The policy neural network 106 can be any appropriate neural network that processes the policy input to generate the policy output.

As one example, the policy neural network 106 can be a feedforward neural network, e.g., a multi-layer perceptron (MLP), that processes the combined representation for each node independently to generate the distribution for the node.

As another example, the policy neural network 106 can be a Transformer-based neural network that processes the combined representations in the policy input jointly to generate the policy output, i.e., that incorporates context from other nodes when generating the distribution for any given node.

A constraint engine 108 within the system 100 then generates a final placement 112 that satisfies the one or more constraints using the policy output 107.

In particular, the constraint engine 108 assigns the nodes to devices one after the other according to a node order.

More specifically, for each particular node in the order, the engine 108 identifies a subset of the hardware devices that would satisfy the one or more constraints if the particular node were assigned to the hardware device given the assignment of any nodes that precede the particular node in the node order. The engine 108 then assigns, using the policy output 107, the particular node to a hardware device in the subset of devices. That is, the engine 108 uses the policy output 107 to guide the assignment of nodes to device as the engine steps through the node order. This is in contrast to directly assigning the nodes to devices using the scores in the policy output 107, i.e., greedily assigning each node to the device that has the highest score or sampling a device for each node in accordance to the scores.

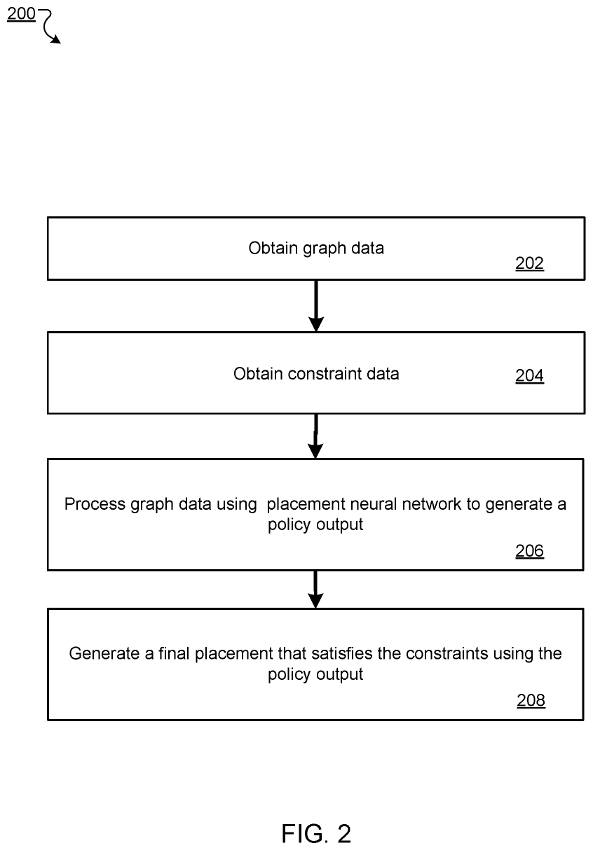

Assigning the nodes using the policy output will be described in more detail below with reference to FIG. 2.

Generally, in order for the system 100 to generate accurate final placements for computational graphs, a training system, i.e., the system 100 or another system, trains the neural network 102 through reinforcement learning (RL). During the RL training, the training system generates rewards based on the performance of final placements that are generated by the constraint engine, rather than placements that are directly generated from the policy outputs generated by the neural network 102.

In some cases, once the neural network 102 has been trained, the system 100 uses the neural network 102 to generate a placement for a new graph in a “zero shot” manner, i.e., while holding the trained values of the parameters fixed. For example, the system 100 can generate a single placement or can generate multiple placements without adjusting the trained parameter values and then select the generated placement that results in the highest throughput as the final placement.

In some other cases, once the neural network 102 has been trained, the system 100 uses the neural network 102 to generate a placement for a new graph in a “fine tuning” manner, i.e., the system 100 further adjusts the trained values of the parameters through reinforcement learning on rewards computed only for placements for the new graph and then generates the final placement using the further adjusted values as described above.

Training the neural network 102 through reinforcement learning is described below with reference to FIG. 2.

Once the final placement 112 for the computational graph is determined, the system 100 can schedule the operations of the graph for processing by the plurality of hardware devices, i.e., by causing the operations of the graph to be executed according to the final placement 112. In particular, in some cases, for each operation in the graph, the system 100 can execute the graph by causing the device to which the operation was assigned in the final placement 112 to execute the operation during the execution of the computational graph. In some cases, the system 100 can provide data identifying the final placement 112 to another system that manages the execution of the graph so that the other system can place the operations across the devices according to the final placement 112.

FIG. 2 is a flow diagram of an example process 200 for determining a placement of a computational graph. For convenience, the process 200 will be described as being performed by a system of one or more computers located in one or more locations. For example, a device placement system, e.g., the device placement system 100 of FIG. 1, appropriately programmed in accordance with this specification, can perform the process 200.

The system obtains graph data specifying a computational graph to be executed on a plurality of hardware devices (step 202). As described above, the computational graph includes a plurality of nodes representing operations and a plurality of edges that represent data dependencies between the operations represented by the plurality of nodes.

The system obtains constraint data specifying one or more constraints on the execution of the computational graph (step 204).

The system processes the graph data using a placement neural network to generate a policy output (step 206). The policy output includes, for each node, a respective score distribution that includes a respective score for each of the plurality of hardware devices.

In some implementations, the system directly generates the policy output in a single iteration of the processing of the placement neural network. That is, when the placement neural network includes a feature extraction network and a policy network, the system processes the graph data using the feature extraction network to generate a feature representation and then processes a policy input that includes only the feature representation using the policy network to generate the policy output.

In some other implementations, the system performs a plurality of processing iterations to generate the policy output. This is described in more detail below with reference to FIG. 3.

The system generates a final placement that satisfies the constraints using the policy output (step 208). In particular, the system assigns the nodes one after the other according to a node order.

For each particular node in the order, i.e., after assigning the previous nodes in the order, the system first identifies a subset of the hardware devices that would satisfy the one or more constraints if the particular node were assigned the hardware device given the assignment of any nodes that precede the particular node in the node order and then assigns, using the policy output, the particular node to a hardware device in the identified subset of devices. If the identified subset for any given node is empty, i.e., the node cannot be assigned to any device without violating the constraints, the system can re-start the assignment process at the first node in the order, can return to the immediately preceding node in the order, or return to another point in the assignment process.

The system can perform this traversal of the nodes according to the node order in any of a variety of ways.

As one example, the system can order the nodes randomly or according to one or more heuristics. For each particular node in the order, i.e., after assigning the previous nodes in the order, the system generates a modified score distribution for the particular node by restricting the respective score distribution for the particular node in the policy output to only the identified subset of the hardware devices, i.e., by setting to zero the score for any device that is not in the identified subset. Optionally, the system can then normalize the scores so that the scores are probabilities, i.e., sum to 1.

The system then samples a hardware device using the modified score distribution.

As another example, the system can first generate an initial placement by assigning each node to a respective hardware device using the respective score distribution for the node in the policy output, i.e., by greedily assigning the node to the device with the highest score in the score distribution or by sampling a device for the node from the score distribution.

The system can then order the nodes randomly or according to one or more heuristics. For each particular node in the order, i.e., after assigning the previous nodes in the order, the system can determine whether the device to which the node is assigned in the initial placement is in the identified subset of the hardware devices; and, in response to determining that the device to which the node is assigned is in the identified subset, assigning the node to the same device as in the initial placement. If the device to which the node is assigned in the initial placement is not in the identified subset of the hardware devices, the system can assign a node to a random device from the initial subset or select a device from the initial subset using one or more heuristics.

In some cases, the system or another system has already trained the placement neural network through reinforcement learning on a training data set of one or more computational graphs. In some of these cases, the training data set does not include the computational graph for which the process 200 is being performed, i.e., the system performs the placement in a “zero shot” manner.

In some other cases, the system performs the process 200 as part of training the placement neural network through reinforcement learning.

In particular, in these cases, the system determines a reward for the final placement based on an execution of the computational graph with each operation being performed on the respective hardware device to which the node representing the operation is assigned in the final placement and updating the parameters of the placement neural network based on the reward through reinforcement learning. That is, unlike other approaches that attempt to train a neural network to place computation graph, the system bases the reward on the performance of the final placement that is generated by the constraint engine rather than on the performance of a placement generated directly from the output of the neural network.

For example, the reward can measure (i) a throughput of the execution of the computational graph with each operation being performed on the respective hardware device to which the node representing the operation is assigned in the final placement, (ii) a latency of the execution of the computational graph with each operation being performed on the respective hardware device to which the node representing the operation is assigned in the final placement, or (iii) both. For example, the reward can be equal to the throughput (as measured in any appropriate unit), equal to the throughput raised to a constant power, or equal to the throughput multiplied by or summed with a constant value. As another example, the reward can be equal to the negative of the latency (as measured in any appropriate unit), equal to the negative of the latency raised to a constant power, or equal to the negative of the latency multiplied by or summed with a constant value.

The system can use any appropriate reinforcement learning technique to update the parameters to optimize expected rewards. Examples of such techniques include policy gradient techniques, e.g., REINFORCE or Proximal Policy Optimization (PPO).

FIG. 3 is a flow diagram of an example process 300 for generating a policy output. For convenience, the process 300 will be described as being performed by a system of one or more computers located in one or more locations. For example, a device placement system, e.g., the device placement system 100 of FIG. 1, appropriately programmed in accordance with this specification, can perform the process 300.

The system processes the graph data using the feature extraction neural network to generate the feature representation of the computational graph (step 302).

The system initializes a state feature representation of a current candidate placement of the computational graph (step 304). This state feature representation includes a respective state embedding for each of the nodes in the graph. For example, the system can initialize the feature representation to be equal to the representation of a placement that randomly assigns each node to a device or by assigning the feature representation to a predetermined representation that indicates that the graph has not yet been placed.

The system then performs steps 306 and 308 at each of a plurality of iterations. Generally the number of iterations is much smaller than the number of nodes in the graph, i.e., the number of operations that need to be placed. For example, the system can perform between ten and two hundred iterations even when the graph has over ten thousand nodes.

The system generates a current policy input for the iteration from the feature representation of the computational graph and the feature representation of the candidate placement (step 306). For example the current policy input can be a concatenation, a sum, or an average of the current policy input and the feature representation.

The system processes the current policy input using the policy neural network to generate a current policy output (step 308), i.e., as described above.

At each iteration other than the last iteration of the plurality of iterations, the system generates an updated candidate placement by assigning each node in the computational graph to a respective hardware device using the current policy output generated at the iteration.

The system then updates the feature representation to represent the updated candidate placement. Generally, the feature representation of a given candidate placement includes, for each node, a learned embedding that represents the device to which the node is assigned in the given candidate placement. These learned device embeddings can be learned jointly with the training of the neural network through reinforcement learning.

The system uses the current policy output generated at the last iteration of the plurality of iterations as the final policy output (step 310).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few:

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining graph data specifying a computational graph to be executed on a plurality of hardware devices, the computational graph comprising a plurality of nodes representing operations and a plurality of edges that represent data dependencies between the operations represented by the plurality of nodes;
obtaining constraint data specifying one or more constraints on the execution of the computational graph; and
generating a final placement that assigns each node of the computational graph to a respective hardware device of the plurality of hardware devices and that satisfies the one or more constraints, the generating comprising:
processing the graph data using a placement neural network to generate a policy output that comprises, for each node, a respective score distribution that includes a respective score for each of the plurality of hardware devices; and
generating the final placement by assigning the nodes one after the other according to a node order, comprising, for each particular node:
identifying a subset of the hardware devices that would satisfy the one or more constraints if the particular node were assigned the hardware device given the assignment of any nodes that precede the particular node in the node order; and
assigning, using the policy output, the particular node to a hardware device in the subset of devices.

2. The method of claim 1, further comprising:
providing data specifying the final placement for use in executing the computational graph on the plurality of hardware devices in accordance with the final placement.

3. The method of claim 1, further comprising:
executing the computational graph on the plurality of hardware devices, comprising performing each operation on the respective hardware device to which the node representing the operation is assigned in the final placement.

4. The method of claim 1, wherein the placement neural network comprises a feature extraction neural network and a policy neural network, and wherein processing the graph data using the placement neural network comprises:
processing the graph data using the feature extraction neural network to generate a feature representation of the computational graph; and
processing a policy input comprising the feature representation of the computational graph using the policy neural network to generate the policy output.

5. The method of claim 4, wherein processing the graph data using the placement neural network comprises:
initializing a feature representation of a candidate placement that assigns each node in the computational graph to a respective hardware device from the plurality of hardware devices;
at each of a plurality of iterations:
generating a current policy input for the iteration from the feature representation of the computational graph and the feature representation of the candidate placement; and
processing the current policy input to generate a current policy output; and
at each iteration other than a last iteration of the plurality of iterations, generating an updated candidate placement by assigning each node in the computational graph to a respective hardware device using the current policy output generated at the iteration and updating the feature representation to represent the updated candidate placement;
wherein the policy output is the current policy output generated at the last iteration of the plurality of iterations.

6. The method of claim 5, wherein generating the current policy input comprises:
generating a feature representation of the candidate placement; and
combining the feature representation of the computational graph and the feature representation of the candidate placement.

7. The method of claim 4, wherein the feature extraction neural network is a graph neural network and the feature representation of the computational graph comprises a respective embedding of each of the nodes in the computational graph.

8. The method of claim 5, wherein the feature representation of the candidate placement comprises, for each of the nodes, a respective embedding of the assignment of the node in the candidate placement.

9. The method of claim 1, further comprising:
determining a reward for the final placement based on an execution of the computational graph with each operation being performed on the respective hardware device to which the node representing the operation is assigned in the final placement; and
updating the parameters of the placement neural network based on the reward through reinforcement learning.

10. The method of claim 10, wherein the reward measures a throughput of the execution of the computational graph, a latency of the execution of the computational graph, or both.

11. The method of claim 1, wherein the placement neural network has been trained through reinforcement learning on a training data set of one or more training computational graphs.

12. The method of claim 11, wherein the training data set does not include the computational graph.

13. The method of claim 1, wherein each device is connected to only a proper subset of the other devices by an inter-chip link, and wherein:
the one or more constraints comprise a first constraint that specifies that any two nodes that are connected by an edge in the computational graph are assigned to either a same device or to two different devices that are connected to each other by an inter-chip link.

14. The method of claim 1, wherein links between devices in the plurality of device are uni-directional, and wherein:
the one or more constraints comprise a second constraint that specifies that, for each edge in the computational graph that connects a respective first node to a respective second node, the respective first and second nodes are either assigned to the same device or the respective second node is assigned to a second device that is reachable by a uni-directional link from a first device to which the respective first node is assigned.

15. The method of claim 1, wherein assigning, using the policy output, the particular node to a hardware device in the subset of devices comprises:
generating a modified score distribution for the particular node by restricting the respective score distribution for the particular node to only the identified subset of the hardware devices; and
sampling a hardware device using the modified score distribution.

16. The method of claim 1, wherein generating the final placement further comprises:
generating an initial placement by assigning each node to a respective hardware device using the respective score distribution for the node; and wherein assigning, using the policy output, the particular node to a hardware device in the subset of devices comprises:
determining whether the device to which the node is assigned in the initial placement is in the identified subset of the hardware devices; and
in response to determining that the device to which the node is assigned is in the identified subset, assigning the node to the same device as in the initial placement.

17. (canceled)

18. One or more non-transitory computer storage media storing instructions that when executed by one or more computers cause the one or more computers to perform operations comprising:
obtaining graph data specifying a computational graph to be executed on a plurality of hardware devices, the computational graph comprising a plurality of nodes representing operations and a plurality of edges that represent data dependencies between the operations represented by the plurality of nodes;
obtaining constraint data specifying one or more constraints on the execution of the computational graph; and
generating a final placement that assigns each node of the computational graph to a respective hardware device of the plurality of hardware devices and that satisfies the one or more constraints, the generating comprising:
processing the graph data using a placement neural network to generate a policy output that comprises, for each node, a respective score distribution that includes a respective score for each of the plurality of hardware devices; and
generating the final placement by assigning the nodes one after the other according to a node order, comprising, for each particular node:
identifying a subset of the hardware devices that would satisfy the one or more constraints if the particular node were assigned the hardware device given the assignment of any nodes that precede the particular node in the node order; and
assigning, using the policy output, the particular node to a hardware device in the subset of devices.

19. A system comprising one or more computers and one or more storage devices storing instructions that when executed by the one or more computers cause the one or more computers to perform operations comprising:
obtaining graph data specifying a computational graph to be executed on a plurality of hardware devices, the computational graph comprising a plurality of nodes representing operations and a plurality of edges that represent data dependencies between the operations represented by the plurality of nodes;
obtaining constraint data specifying one or more constraints on the execution of the computational graph; and
generating a final placement that assigns each node of the computational graph to a respective hardware device of the plurality of hardware devices and that satisfies the one or more constraints, the generating comprising:
processing the graph data using a placement neural network to generate a policy output that comprises, for each node, a respective score distribution that includes a respective score for each of the plurality of hardware devices; and
generating the final placement by assigning the nodes one after the other according to a node order, comprising, for each particular node:
identifying a subset of the hardware devices that would satisfy the one or more constraints if the particular node were assigned the hardware device given the assignment of any nodes that precede the particular node in the node order; and
assigning, using the policy output, the particular node to a hardware device in the subset of devices.

20. The system of claim 19, the operations further comprising:
providing data specifying the final placement for use in executing the computational graph on the plurality of hardware devices in accordance with the final placement.

21. The system of claim 19, the operations further comprising:
executing the computational graph on the plurality of hardware devices, comprising performing each operation on the respective hardware device to which the node representing the operation is assigned in the final placement.
